(19) United States
(12) Patent Application Publication
(10) Pub. No.: US 2026/0181287 A1
(43) Pub. Date: Jun. 25, 2026

(54) IMAGING DEVICE AND SIGNAL PROCESSING CIRCUIT

(71) Applicant: CANON KABUSHIKI KAISHA, Tokyo (JP)

(72) Inventors: YUUTA OOSHIMA, Saitama (JP); MASASHI NIWA, Chiba (JP)

(21) Appl. No.: 19/423,627

(22) Filed: Dec. 17, 2025

(30) Foreign Application Priority Data
Dec. 23, 2024 (JP) 2024-226166

(51) Int. Cl. H04N 25/773; H04N 25/42; H04N 25/771

(52) U.S. Cl. CPC H04N 25/773; H04N 25/42; H04N 25/771

(57) ABSTRACT

An imaging device includes a pixel, the pixel includes a light receiving unit configured to receive light and generate a pulse signal, a counter configured to count the pulse signal and hold a count value of a plurality of bits, a holding unit configured to hold the count value, and a switching unit configured to switch the bit values of the count value to be held in the holding unit. The switching unit causes the holding unit to hold one or more higher-order bits of the count value a plurality of times. The holding unit outputs the plurality of higher-order bits.

### BACKGROUND

### Field of the Technology

The present disclosure relates to an imaging device and a signal processing circuit.

### Description of the Related Art

Conventionally, an imaging device may include a plurality of pixels each having a photoelectric conversion unit that detects a photon and outputs a pulse signal and a counter that counts the pulse signal from the photoelectric conversion unit. In order to arrange the pixels at high density, it is desired to miniaturize each of the pixels. When the pixel is miniaturized, it is conceivable to reduce a bit width of the counter, but when the bit width is reduced, the counter may be saturated. In an imaging device disclosed in Japanese Patent Laid-Open No. 2019-110409, a memory is provided outside a pixel, and a pixel signal including a higher-order bit of a counter is output to the memory before the counter is saturated. Accordingly, the saturation of the counter is suppressed while the bit width of the counter is reduced.

However, in Japanese Patent Laid-Open No. 2019-110409, an output interval of the pixel signal from the counter to the memory becomes short, and noise may be generated in the pixel signal due to wiring resistance between the counter and the memory. On the other hand, it is conceivable to lengthen an exposure period when detecting photons to slow down the count speed and lengthen the output interval of the pixel signal, but in this case, a frame rate decreases.

### SUMMARY

The present disclosure is directed to provide an imaging device and a signal processing circuit capable of achieving both downsizing of a pixel and a high frame rate.

According to one aspect of the present specification, there is provided an imaging device including a pixel, the pixel including: a light receiving unit configured to receive light and generate a pulse signal; a counter configured to count the pulse signal and hold a count value of a plurality of bits; a holding unit configured to hold the count value; and a switching unit configured to switch bit values of the count value to be held in the holding unit, wherein the switching unit causes the holding unit to hold one or more higher-order bits of the count value a plurality of times, and wherein the holding unit outputs a plurality of higher-order bits.

According to one aspect of the present specification, there is provided a signal processing circuit including: a counter configured to count a pulse signal from a light receiving unit and hold a count value of a plurality of bits; a shift register configured to hold the count value; and a switching unit configured to switch bit values of the count value to be held in the shift register, wherein the switching unit causes the shift register to hold one or more higher-order bits of the count value a plurality of times, wherein the shift register outputs a plurality of higher-order bits.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an imaging device according to a first embodiment.

FIG. 2 is an exploded perspective view of the imaging device according to the first embodiment.

FIG. 3 is a block diagram of an imaging unit according to the first embodiment.

FIG. 4 is a circuit diagram of a pixel according to the first embodiment.

FIG. 5 is a diagram illustrating a first operation mode of a switching unit according to the first embodiment.

FIG. 6 is a diagram illustrating a second operation mode of the switching unit according to the first embodiment.

FIG. 7 is a timing chart of the imaging unit according to the first embodiment.

FIG. 8 is a block diagram of an equipment according to a second embodiment.

FIGS. 9A and 9B are block diagrams of an equipment according to a third embodiment.

### DESCRIPTION OF THE EMBODIMENTS

### First Embodiment

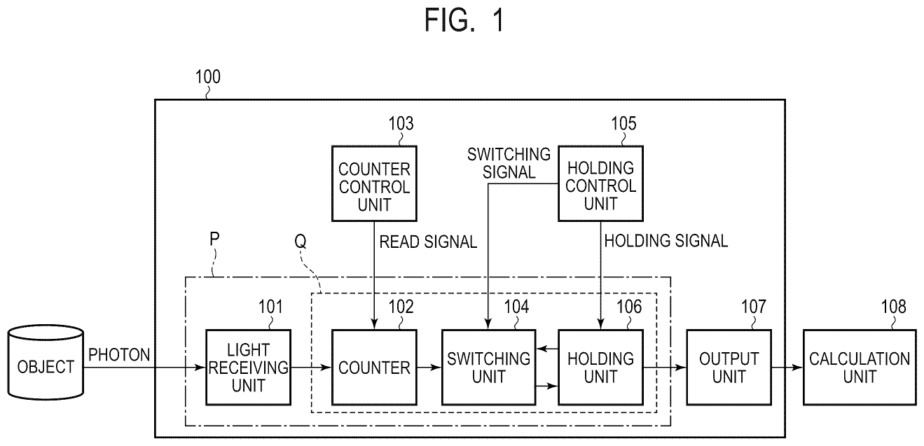

FIG. 1 is a block diagram of an imaging device according to the present embodiment. The imaging device includes an imaging unit 100 and a calculation unit 108. The imaging unit 100 includes a pixel P, a counter control unit 103, a holding control unit 105, and an output unit 107. The pixel P includes a light receiving unit 101 and a signal processing circuit Q. The signal processing circuit Q includes a counter 102, a switching unit 104, and a holding unit 106.

The light receiving unit 101 includes a photoelectric conversion element 111, a quenching element, and a waveform shaping unit, which will be described later. The photoelectric conversion element 111 may be an avalanche photodiode (hereinafter referred to as APD). By supplying a reverse bias voltage that induces an avalanche multiplication operation to the APD, an exposure of the APD is started. When a photon from an object enters the APD, charges generated by the incidence of the photon cause avalanche multiplication, and an avalanche current is generated. The operation modes of the APD include a Geiger mode and a linear mode. In the Geiger mode, the reverse bias voltage applied between an anode and a cathode is set to be higher than a breakdown voltage of the APD. In the linear mode, the reverse bias voltage applied between the anode and the cathode is close to or lower than the breakdown voltage of the APD. When operating in Geiger mode, the APD is called a SPAD (Single Photon Avalanche Diode). The APD may operate in a linear mode or a Geiger mode.

The quenching element converts a change in the avalanche current generated in the APD into a voltage signal. The waveform shaping unit converts the voltage signal into a pulse signal and outputs the pulse signal to the counter 102.

The counter 102 counts the pulse signal from the light receiving unit 101 and holds a count value of a plurality of bits. When the bit width of the count value is N bits, the higher-order bits of the count value are defined as M bits counted from the MSB (Most Significant Bit) among the N bits. Here, it is assumed that N=3 and M=1, and the higher-order bit is the MSB. The lower-order bits of the count value are (N-M) bits obtained by removing the higher-order bits from the N bits.

The counter control unit 103 outputs a drive signal to the counter 102 to drive the counter 102 and stops the counter 102 by stopping the drive signal. The counter control unit 103 outputs a read signal to the counter 102 to read the count value.

The switching unit 104 switches the bit value to be held in the holding unit 106 among the bit values of the count value of the counter 102. The switching unit 104 causes the holding unit 106 to hold one or more higher-order bits of the count value a plurality of times. In addition, the switching unit 104 causes the holding unit 106 to hold all bits of the count value of the counter 102.

The holding control unit 105 outputs a switching signal to the switching unit 104, and switches between a first operation mode in which the most significant bit of the count value is held in the holding unit 106 and a second operation mode in which all bits of the count value are held in the holding unit 106. The holding control unit 105 outputs a holding signal to the holding unit 106 and controls the holding unit 106 to hold the most significant bit or all bits of the count value.

The holding unit 106 can hold the most significant bit or all bits of the count value in accordance with the holding signal. The holding unit 106 holds the most significant bit of the count value in the case of the first operation mode and holds all the bits of the count value in the case of the second operation mode.

The output unit 107 outputs the most significant bit or all bits of the count value held in the holding unit 106 to the calculation unit 108 as pixel signals.

The calculation unit 108 receives the pixel signals from the output unit 107, combines a plurality of most significant bits and all bits of the count value, and calculates the pixel value of the pixel P in which the pulse signal is counted. The calculation unit 108 calculates the pixel value of the pixel P by combining a bit value obtained by bit-shifting the number of predetermined logical values (for example, “1”) included in the plurality of most significant bits and all bits of the count value.

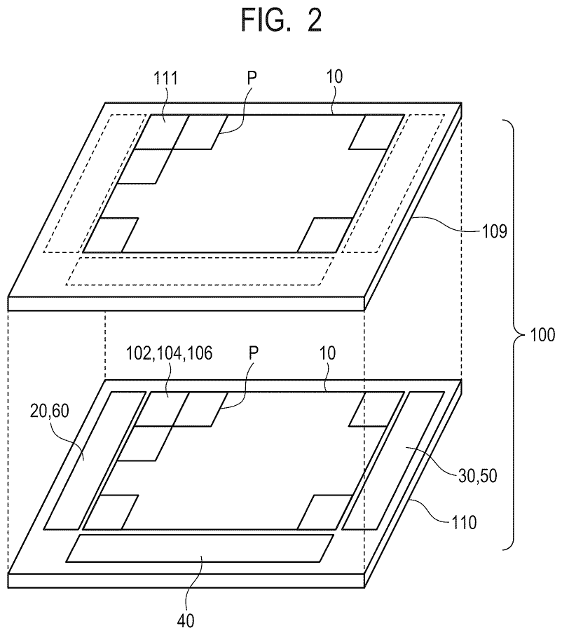

FIG. 2 is an exploded perspective view of the imaging unit 100 according to the present embodiment. The imaging unit 100 is a stacked type in which a sensor substrate 109 and a circuit substrate 110 are stacked and electrically connected to each other. The imaging unit 100 includes a pixel unit 10, a vertical scanning circuit unit 20, a readout circuit unit 30, a horizontal scanning circuit unit 40, an output circuit unit 50, and a control pulse generation unit 60.

The pixel unit 10 includes a plurality of pixels P. The pixels P are arranged in an array so as to form a plurality of rows and a plurality of columns. The number of pixels P constituting the pixel unit 10 is not particularly limited. For example, the pixel unit 10 may include a plurality of pixels P arranged in an array of several thousand rows and several thousand columns as in a general digital camera. Alternatively, the pixel unit 10 may include a plurality of pixels P arranged in one row or one column. Alternatively, the pixel unit 10 may include one pixel P.

A photoelectric conversion element 111 among the constituent elements of the pixel P can be disposed on the sensor substrate 109. Among the constituent elements of the pixel P, the quenching element, the waveform shaping unit, a counter 102, the switching unit 104, and the holding unit 106 can be disposed on the circuit substrate 110. In addition, the vertical scanning circuit unit 20, the readout circuit unit 30, the horizontal scanning circuit unit 40, the output circuit unit 50, the control pulse generation unit 60, and the like may be further disposed on the circuit substrate 110.

The photoelectric conversion element 111 of the sensor substrate 109 and the quenching element, the waveform shaping unit, the counter 102, the switching unit 104, and the holding unit 106 of the circuit substrate 110 are provided so as to overlap each other in a plan view. That is, the photoelectric conversion element 111, the quenching element, the waveform shaping unit, the counter 102, the switching unit 104, and the holding unit 106 are included in a region in the pixel P in a plan view. The vertical scanning circuit unit 20, the readout circuit unit 30, the horizontal scanning circuit unit 40, the output circuit unit 50, and the control pulse generation unit 60 may be disposed around the pixel unit 10. Here, the term “plan view” refers to a view from a direction perpendicular to the surface of the sensor substrate 109.

By configuring the stacked imaging unit 100, it is possible to increase the degree of integration of elements and achieve higher functionality. The photoelectric conversion element 111 is disposed on one substrate, and the quenching element, the waveform shaping unit, the counter 102, the switching unit 104, and the holding unit 106 are disposed on the other substrate. As a result, the photoelectric conversion elements 111 can be arranged at high density without sacrificing the light receiving area of the photoelectric conversion elements 111, and the size of the imaging unit 100 can be reduced.

The imaging unit 100 is not limited to a configuration in which two substrates are stacked, and for example, three or more substrates may be stacked, or one substrate may be used.

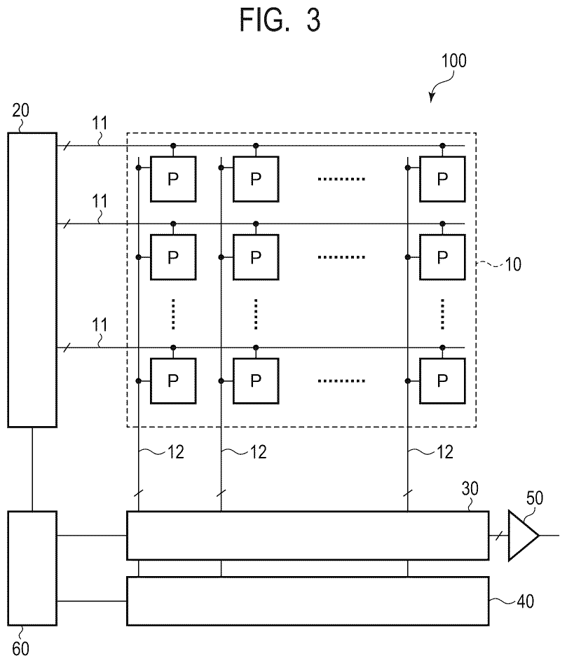

FIG. 3 is a block diagram of the imaging unit 100 according to the present embodiment. In each row of the pixel array of the pixel unit 10, a control line 11 extends in a first direction (lateral direction in FIG. 1). The control lines 11 are connected to the pixels P arranged in the first direction, respectively, and form signal lines common to the pixels P. The pixels P arranged in the same row are controlled by the same control line 11. Each of the control lines 11 may include a plurality of signal lines for supplying a plurality of types of control signals to the pixels P. The control line 11 of each row is connected to the vertical scanning circuit unit 20.

In each column of the pixel array of the pixel unit 10, the data line 12 extends in a second direction (vertical direction in FIG. 1) intersecting the first direction. The data lines 12 are connected to the pixels P arranged in the second direction, respectively, and form signal lines common to the pixels P. Each of the data lines 12 may include a plurality of signal lines for transferring a digital signal of a plurality of bits output from the pixel P in parallel for each bit.

The vertical scanning circuit unit 20 receives a control signal from the control pulse generation unit 60, generates a control signal for driving the pixel P, and supplies the control signal to the pixel P via the control line 11. The vertical scanning circuit unit 20 may include a logic circuit such as a shift register and an address decoder. The vertical scanning circuit unit 20 includes a counter control unit 103 and a holding control unit 105. The vertical scanning circuit unit 20 sequentially scans the pixels P in the pixel unit 10 in units of rows, and sequentially outputs pixel signals of the pixels P to the readout circuit unit 30 via the data lines 12. Thus, an image of one frame is acquired.

The data line 12 of each column is connected to the readout circuit unit 30. The readout circuit unit 30 includes a plurality of holding units provided corresponding to each column of the pixel array of the pixel unit 10. The readout circuit unit 30 holds the pixel signal of the pixel P of each column output from the pixel unit 10 in units of rows via the data line 12 in the holding unit of the corresponding column.

The horizontal scanning circuit unit 40 receives a control signal from the control pulse generation unit 60, generates a control signal for reading out a pixel signal from the holding unit of each column of the readout circuit unit 30, and supplies the control signal to the readout circuit unit 30. The horizontal scanning circuit unit 40 may include a logic circuit such as a shift register and an address decoder. The horizontal scanning circuit unit 40 sequentially scans the holding units of each column of the readout circuit unit 30 and sequentially causes the readout circuit unit 30 to output the pixel signals held in the holding units to the output circuit unit 50.

The output circuit unit 50 includes an external interface circuit, and outputs the pixel signal output from the readout circuit unit 30 to the calculation unit 108 outside the imaging unit 100. The external interface circuit included in the output circuit unit 50 is not particularly limited. A SerDes (SERializer/DESerializer) transmission circuit is applicable to the external interface circuit. In the SerDes transmission circuit, for example, a LVDS (Low Voltage Differential Signaling) circuit, a SLVS (Scalable Low Voltage Signaling) circuit, or the like is applied.

The control pulse generation unit 60 generates a control signal for controlling the operations and timings of the vertical scanning circuit unit 20, the readout circuit unit 30, and the horizontal scanning circuit unit 40, and supplies the control signal to each functional block.

At least a part of the control signals for controlling the operations and timings of the vertical scanning circuit unit 20, the readout circuit unit 30, and the horizontal scanning circuit unit 40 may be supplied from the outside of the imaging unit 100.

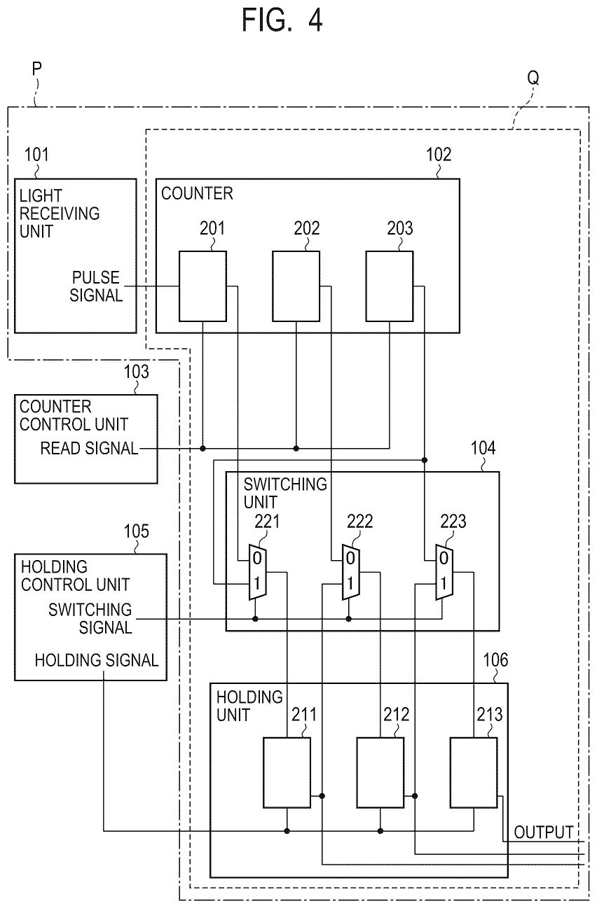

FIG. 4 is a circuit diagram of the pixel P according to the present embodiment. The counter 102 includes a first bit counter 201, a second bit counter 202, and a third bit counter 203. Each bit counter holds one bit and the counter 102 may hold a total of three bits. That is, the counter 102 can count from 0 to 7 in decimal. Each bit counter may be, for example, a flip-flop, but may be another element. The first bit counter 201, the second bit counter 202, and the third bit counter 203 are connected to the counter control unit 103.

The holding unit 106 includes a first bit register 211, a second bit register 212, and a third bit register 213. Each bit register holds one bit, and the holding unit 106 may hold a total of three bits. That is, the holding unit 106 can hold from 0 to 7 in decimal.

Each bit register may be, for example, a flip-flop, but may be other elements. The first bit register 211, the second bit register 212, and the third bit register 213 are connected to the holding control unit 105. The first bit register 211, the second bit register 212, and the third bit register 213 are connected to the data line 12, and output bit values in parallel.

The switching unit 104 includes a first selector 221, a second selector 222, and a third selector 223. The first selector 221, the second selector 222, and the third selector 223 are connected to the holding control unit 105. When the switching signal “1” is output from the holding control unit 105, the switching unit 104 controls each selector to switch to the first operation mode. When the switching signal “0” is output from the holding control unit 105, the switching unit 104 switches to the second operation mode.

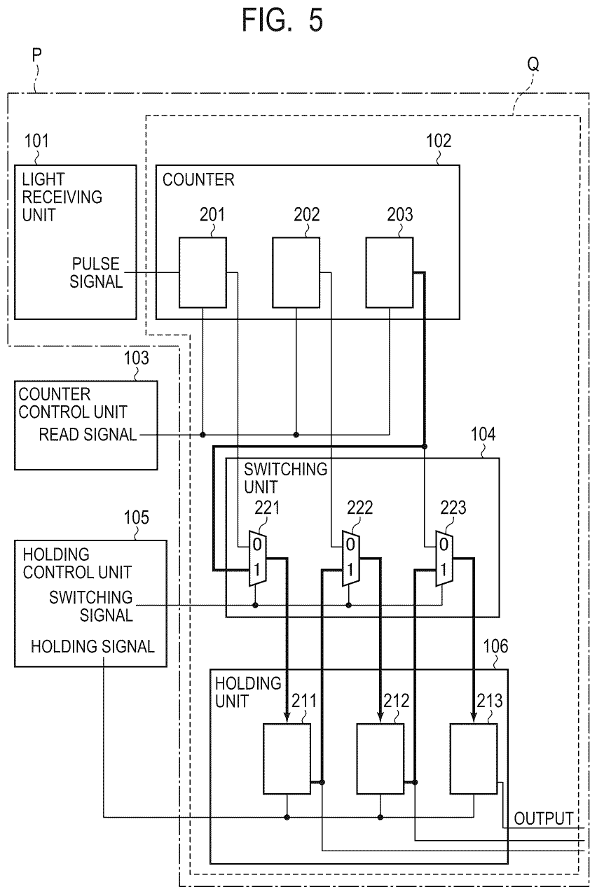

FIG. 5 is a diagram illustrating the first operation mode of the switching unit 104 according to the present embodiment. When the switching signal “1” is output from the holding control unit 105 and the switching unit 104 is switched to the first operation mode, the first selector 221 electrically connects the third bit counter 203 and the first bit register 211. The second selector 222 electrically connects the first bit register 211 and the second bit register 212. The third selector 223 electrically connects the second bit register 212 and the third bit register 213. Thus, the holding unit 106 functions as a shift register that sequentially shifts bits from the first bit register 211 toward the third bit register 213. The holding unit 106 can hold the bit value of the third bit counter 203 in the first bit register 211.

In the first operation mode, the holding unit 106 receives the holding signal from the holding control unit 105 and sequentially shifts and holds each of the plurality of most significant bits of the count value. That is, the holding unit 106 shifts the bit of the second bit register 212 to the third bit register 213 and shifts the bit of the first bit register 211 to the second bit register 212. The counter 102 receives the read signal from the counter control unit 103, outputs the bit of the third bit counter 203 (the most significant bit of the count value) to the holding unit 106 and clears the third bit counter 203 to “0” after the output. The holding unit 106 holds the most significant bit of the count value in the first bit register 211.

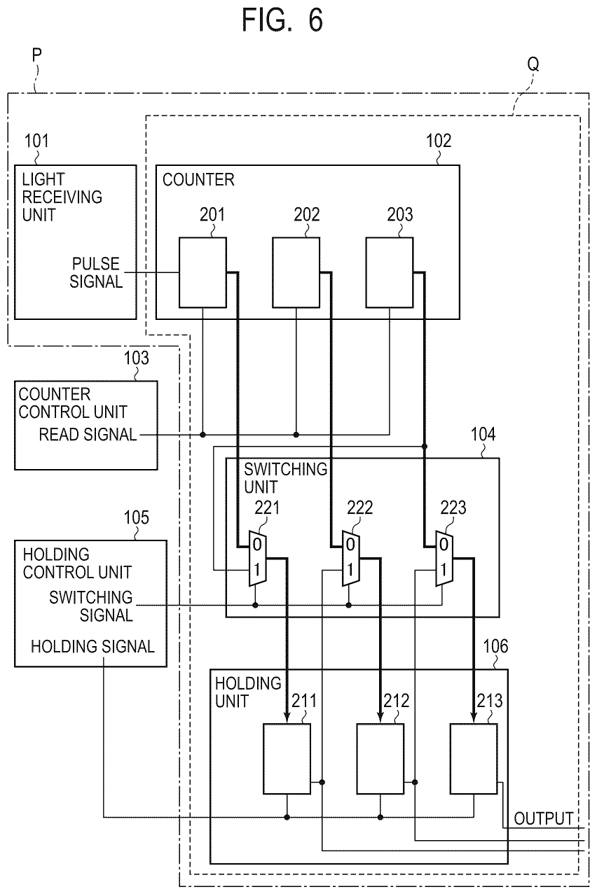

FIG. 6 is a diagram illustrating the second operation mode of the switching unit 104 according to the present embodiment. When the switching signal “0” is output from the holding control unit 105 and the switching unit 104 is switched to the second operation mode, the first selector 221 electrically connects the first bit counter 201 and the first bit register 211. The second selector 222 electrically connects the second bit counter 202 and the second bit register 212. The third selector 223 electrically connects the third bit counter 203 and the third bit register 213. Thus, each bit register of the holding unit 106 may hold a bit value from each bit counter of the counter 102.

In the second operation mode, the counter 102 receives the read signal from the counter control unit 103 and outputs all bit values (count value) of the counter 102 to the holding unit 106. The holding unit 106 holds the bit value of the first bit counter 201 in the first bit register 211, holds the bit value of the second bit counter 202 in the second bit register 212, and holds the bit value of the third bit counter 203 in the third bit register 213.

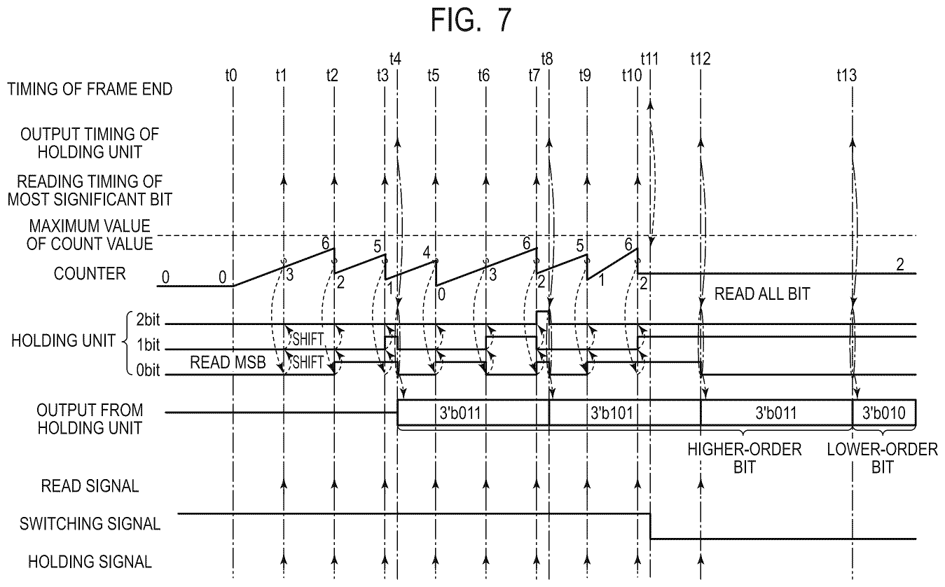

FIG. 7 is a timing chart of the imaging unit 100 according to the present embodiment. FIG. 7 illustrates control of one pixel P among the plurality of pixels P in the pixel unit 10. Arrows in the vertical direction from time t1 to time t13 indicate the timing of the operation.

At time t0, the light receiving unit 101 starts exposure, and outputs a pulse signal to the counter 102 in response to incidence of a photon. The counter 102 counts pulse signals from the light receiving unit 101. Before the exposure is started, the counter 102 and the holding unit 106 are reset, and the switching unit 104 is switched to the first operation mode.

At time t1, the holding control unit 105 outputs a holding signal to the holding unit 106 and shifts the bit “0” of the second bit register 212 to the third bit register 213. In addition, the holding control unit 105 shifts the bit “0” of the first bit register 211 to the second bit register 212. The count value of the counter 102 is “011” in binary (“3” in decimal). Since the most significant bit of the count value is “0”, the third bit counter 203 holds “0”. The counter control unit 103 outputs a read signal to the counter 102, and causes the counter 102 to output the bit (most significant bit) “0” of the third bit counter 203 to the holding unit 106. The holding unit 106 holds the bit “0” from the counter 102 in the first bit register 211. The holding unit 106 holds “000” in binary.

The period (first period) in which the most significant bit of the counter 102 is read is until only the most significant bit becomes “1” from the reset state of the counter 102. The first period is preferably set to be shorter than a reading period of the most significant bit assumed to be the shortest in design of the imaging unit 100. Thus, before the counter 102 saturates beyond the maximum value of the count value, the counter control unit 103 can read the most significant bit of the counter 102. The counter control unit 103 clears the third bit counter 203 to “0” after outputting the most significant bit of the counter 102.

At time t2, the holding control unit 105 outputs a holding signal to the holding unit 106 and causes the holding unit 106 to shift the bit “0” of the second bit register 212 to the third bit register 213. In addition, the holding control unit 105 causes the holding unit 106 to shift the bit “0” of the first bit register 211 to the second bit register 212. The count value of the counter 102 is “110” in binary (“6” in decimal). Since the most significant bit of the count value is “1”, the third bit counter 203 holds “1”. The counter control unit 103 outputs a read signal to the counter 102, causes the counter 102 to output the bit “1” of the third bit counter 203 to the holding unit 106, and clears the third bit counter 203 after the output. As a result, the count value of the counter 102 becomes “010” in binary (“2” in decimal). The holding unit 106 holds the bit “1” from the counter 102 in the first bit register 211. The holding unit 106 holds “001” in binary.

At time t3, the holding control unit 105 outputs a holding signal to the holding unit 106 and causes the holding unit 106 to shift the bit “0” of the second bit register 212 to the third bit register 213. In addition, the holding control unit 105 causes the holding unit 106 to shift the bit “1” of the first bit register 211 to the second bit register 212. The holding unit 106 holds “010” in binary. The count value of the counter 102 is “101” in binary (“5” in decimal), and the third bit counter 203 holds “1”. The counter control unit 103 outputs a read signal to the counter 102, causes the counter 102 to output the bit “1” of the third bit counter 203 to the holding unit 106 and clears the third bit counter 203 after the output. As a result, the counter 102 becomes binary “001” (“1” in decimal). The holding unit 106 holds the bit “1” from the counter 102 in the first bit register 211. The holding unit 106 holds “011” in binary.

At time t4, the output unit 107 outputs all bits “011” of the holding unit 106 to the calculation unit 108 outside the pixel P via the data line 12. The period (second period) in which all bits of the holding unit 106 are output is longer than the first period in which the most significant bit of the counter 102 is read. When the bit width of the holding unit 106 is N bits and the number of the higher-order bits is M bits, the second period is from the reset of the holding unit 106 until the higher-order bit of the counter 102 is held in the holding unit 106 N/M times. In the present embodiment, since N=3 and M=1, the second period is from the reset of the holding unit 106 until the most significant bit of the counter 102 is held in the holding unit 106 three times.

In the present embodiment, the plurality of most significant bits are held in the holding unit 106, and the output unit 107 outputs the plurality of most significant bits of the holding unit 106 to the outside of the pixel P via the data line 12.

As a result, as compared with the case where the most significant bit of the count value is output to the outside of the pixel P every time the most significant bit of the count value is read as in the related art, the interval at which the most significant bit of the counter 102 is output to the outside of the pixel P becomes longer. Since the holding unit 106 has three bits, all bits of the holding unit 106 are output every time the most significant bit is read three times, and the output interval of the most significant bit to the outside of the pixel P becomes three times longer than that in the related art. Accordingly, it is possible to suppress the generation of noise in the plurality of most significant bits (pixel signals) due to the wiring resistance of the data line 12 or the like. The output unit 107 outputs all bits “011” of the holding unit 106 to the calculation unit 108. All the bits “011” are the three most significant bits of the count value, in other words, the higher-order bit of the pixel value. After outputting all bits “011”, the output unit 107 resets the holding unit 106.

As described above, at times t1 to t3, the most significant bit of the counter 102 is held in the holding unit 106, and at time t4, a plurality of most significant bits held in the holding unit 106 are output.

Since the operation from time t5 to time t8 is the same as the operation from time t1 to time t4, and the operation from time t9 to time t10 is the same as the operation from time t1 to time t2, the description of the operation from time t5 to time t10 is omitted.

At time t11, the vertical scanning circuit unit 20 stops the exposure of one frame by the light receiving unit 101. In addition, the counter control unit 103 stops the count operation by the counter 102. The count value at the time of stopping the counter 102 is “010” in binary (“2” in decimal). The holding control unit 105 outputs a switching signal “0” to the switching unit 104 and switches the switching unit 104 to the second operation mode.

At time t12, the output unit 107 outputs all bits “011” of the holding unit 106 to the calculation unit 108. All the bits “011” are the three most significant bits of the count value, in other words, the higher-order bit of the pixel value.

At time t12, the counter control unit 103 outputs a read signal to the counter 102 and causes the counter 102 to output all bits “010” to the holding unit 106. All the bits “010” (“2” in decimal) are lower-order bits of the pixel value. The holding control unit 105 outputs a holding signal to the holding unit 106 and causes the holding unit 106 to hold all bits “010” of the counter 102.

At time t13, the output unit 107 outputs all bits “010” of the holding unit 106 to the calculation unit 108.

The calculation unit 108 calculates a pixel value by adding a higher-order bit of the pixel value and a lower-order bit of the pixel value. Specifically, the calculation unit 108 counts the number of predetermined logical value based on “011”, “101”, and “011” in binary input as the higher-order bits of the pixel value at times t4, t8, and t12. Here, the predetermined logical value is “1”. In “011”, “101”, and “011” in binary, the number of “1” is “110” in binary (“6” in decimal). That is, the number in which the most significant bit of the count value is “1”0 is binary “110”. The calculation unit 108 bit-shifts the binary “110”. When the bit width of the counter 102 is N=3 bits, the calculation unit 108 bit-shifts “110” in binary to the left by N-1 bits, that is, 2 bits to calculate “11000” in binary. The “11000” in binary (“24” in decimal) is a higher-order bit of the pixel value. The calculation unit 108 adds the lower-order bit “010” in binary (“2” in decimal) of the pixel value input at time t13 to the higher-order bit “11000” of the pixel value and calculates the “11010” in binary (“26” in decimal) as the pixel value.

As described above, according to the imaging device of the present embodiment, since the most significant bit of the counter 102 is held in the holding unit 106, the bit width of the counter 102 can be reduced. In the pixel P, an area that is decreased by reducing the bit width of the counter 102 is larger than an area that is increased by providing the switching unit 104 and the holding unit 106. As a result, the size of the pixels P is reduced, and the pixels P are arranged at high density. In addition, since the holding unit 106 is provided in the pixel P, the interval at which the most significant bit of the counter 102 is output to the outside of the pixel P via the data line 12 becomes long. Accordingly, it is possible to suppress generation of noise in the pixel signal due to wiring resistance of the data line 12 or the like. That is, the pixel signal is output in a state where the data line 12 is stabilized. Therefore, since it is not necessary to lengthen the exposure period to slow down the count speed and lengthen the output interval of the pixel signal as in the related art, it is possible to suppress a decrease in the frame rate. As described above, the imaging device can achieve both the miniaturization of the pixel P and the high frame rate.

### Second Embodiment

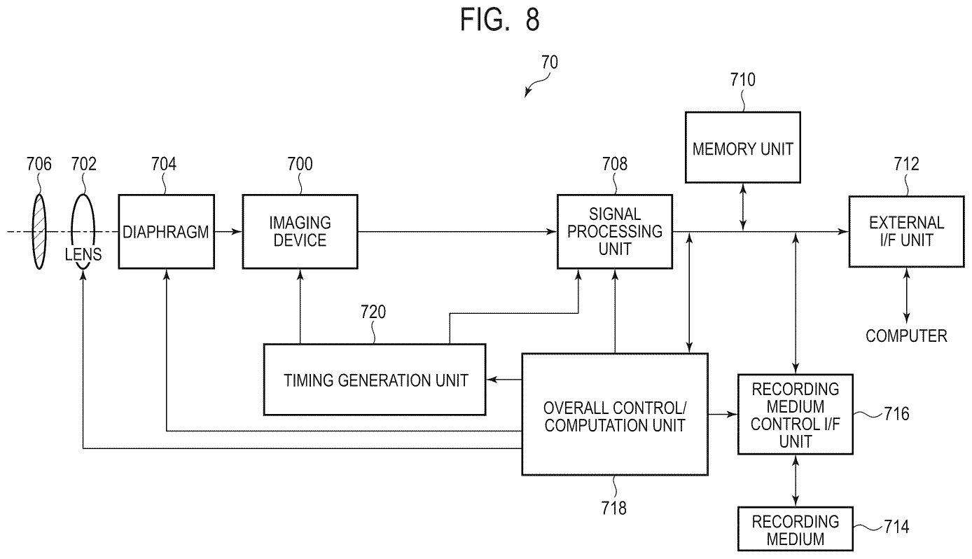

The imaging device in the above-described embodiments can be applied to various devices. Examples of the device include a digital still camera, a digital camcorder, a camera head, a copier, a fax machine, a mobile phone, an in-vehicle camera, an observation satellite, and a monitoring camera. FIG. 8 is a block diagram of a digital still camera.

The device 70 includes an imaging device 700, a lens 702, a diaphragm 704, and a barrier 706. The device 70 further includes a signal processing unit (processing device) 708, a memory unit (storage device) 710, an external I/F unit 712, a recording medium 714, a recording medium control I/F unit 716, an overall control/computation unit (control device) 718, and a timing generation unit 720. At least one of the barrier 706, the lens 702, and the diaphragm 704 is an optical device corresponding to the device. The barrier 706 protects the lens 702, and the lens 702 forms an optical image of a subject on the imaging device 700. The diaphragm 704 makes the amount of light passing through the lens 702 variable. The imaging device 700 is configured as in the above-described embodiment, and converts an optical image formed by the lens 702 into image data (image signal). The signal processing unit 708 performs various corrections, data compression, and the like on the imaging data output from the imaging device 700. The timing generation unit 720 outputs various timing signals to the imaging device 700 and the signal processing unit 708. The overall control/arithmetic unit 718 controls the entire digital still camera, and the memory unit 710 temporarily stores image data. The recording medium control I/F unit 716 is an interface for recording or reading image data on or from the recording medium 714, and the recording medium 714 is a detachable recording medium such as a semiconductor memory for recording or reading imaging data. The external I/F unit 712 is an interface for communicating with an external computer or the like. The timing signal and the like may be input from the outside of the device. The device 70 may further include a display device (a monitor, an electronic viewfinder, or the like) that displays information obtained by the imaging device 700. The device 70 includes at least one of an optical device, a control device, a processing device, a display device, a storage device, and a mechanical device that operates based on information obtained by the imaging device 700. The mechanical device is a movable unit (for example, a robot arm) that operates by receiving a signal from the imaging device 700.

Each pixel may include a plurality of photoelectric conversion units (a first photoelectric conversion unit and a second photoelectric conversion unit). The signal processing unit 708 may be configured to process the pixel signal based on the charge generated in the first photoelectric conversion unit and the pixel signal based on the charge generated in the second photoelectric conversion unit and acquire the distance information from the imaging device 700 to the subject.

### Third Embodiment

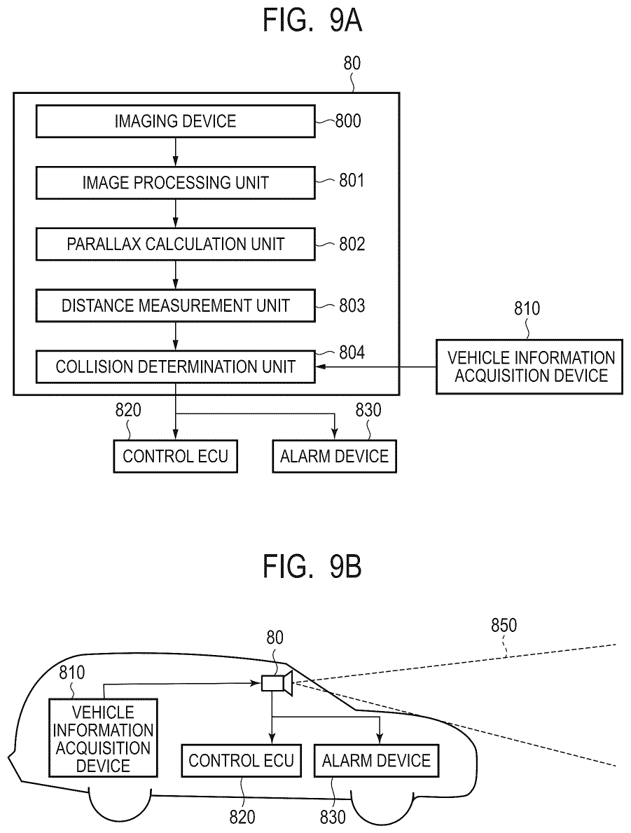

FIGS. 9A and 9B are block diagrams of devices related to an in-vehicle camera according to the present embodiment. The device 80 includes an imaging device 800 of the above-described embodiment and a signal processing device that processes a signal from the imaging device 800. The device 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the device 80. In addition, the device 80 includes a distance measurement unit 803 that calculates a distance to an object based on the calculated parallax, and a collision determination unit 804 that determines whether there is a possibility of collision based on the calculated distance. Here, the parallax calculation unit 802 and the distance measurement unit 803 are examples of a distance information acquisition unit that acquires distance information to an object. That is, the distance information is information related to a parallax, a defocus amount, a distance to an object, and the like. The collision determination unit 804 may determine the collision possibility using any of these pieces of distance information. The distance information acquisition unit may be realized by dedicatedly designed hardware or may be realized by a software module. Also, it may be realized by FPGA (Field Programmable Gate Array), ASIC (Application Specific Integrated Circuit) or a combination thereof.

The device 80 is connected to the vehicle information acquisition device 810 and can acquire vehicle information such as a vehicle speed, a yaw rate, and a steering angle. In addition, a control ECU 820, which is a control device that outputs a control signal for generating a braking force to the vehicle based on the determination result of the collision determination unit 804, is connected to the device 80. The device 80 is also connected to an alarm device 830 that issues an alarm to the driver based on the determination result of the collision determination unit 804. For example, when the determination result of the collision determination unit 804 indicates that the possibility of collision is high, the control ECU 820 performs vehicle control to avoid collision and reduce damage by, for example, applying a brake, returning an accelerator, or suppressing engine output. The alarm device 830 gives an alarm to the user by sounding an alarm such as a sound, displaying alarm information on a screen of a car navigation system or the like, giving vibration to a seat belt or a steering wheel, or the like. The device 80 functions as a control unit that controls the operation of controlling the vehicle as described above.

In the present embodiment, the surroundings of the vehicle, for example, the front or the rear is imaged by the device 80. FIG. 9B illustrates a device in a case of capturing an image in front of the vehicle (imaging range 850). The vehicle information acquisition device 810 serving as the imaging control unit sends an instruction to the device 80 or the imaging device 800 to perform the imaging operation. With such a configuration, the accuracy of distance measurement can be further improved.

In the above description, an example in which control is performed so as not to collide with another vehicle has been described, but the present disclosure is also applicable to control in which automatic driving is performed so as to follow another vehicle, control in which automatic driving is performed so as not to protrude from a lane, and the like. Furthermore, the device can be applied not only to vehicles such as automobiles but also to mobile bodies (mobile devices) such as ships, aircraft, artificial satellites, industrial robots, and consumer robots. In addition, the present disclosure is not limited to mobile object and can be widely applied to devices utilizing object recognition or biological recognition, such as an intelligent traffic system (ITS) and a monitoring system.

### Modified Embodiments

The present disclosure is not limited to the above embodiment, and various modifications are possible. For example, an example in which a part of the configuration of any of the embodiments is added to another embodiment or an example in which a part of the configuration of one embodiment is replaced with another embodiment is also an embodiment of the present disclosure.

Although an example in which the photoelectric conversion element 111 is an APD has been described, the photoelectric conversion element 111 is not limited thereto, and may be, for example, a PD (Photo Diode) or the like.

Although an example in which the counter 102 and the holding unit 106 have a bit width of 3 bits has been described, the present disclosure is not limited thereto, and the bit width may be 2 bits or 4 bits or more.

Although an example in which the counter 102 and the holding unit 106 have the same bit width has been described, the present disclosure is not limited thereto and may have different bit widths.

Although an example in which the higher-order bit of the counter 102 is a MSB has been described, the present disclosure is not limited thereto, and the higher-order bits may be, for example, two bits counted from the MSB. In this case, when the bit width of the holding unit 106 is configured by four bits, the output interval of the pixel signal becomes twice as long as that in the related art.

Although an example in which the output unit 107 resets the holding unit 106 after outputting all bits of the holding unit 106 at times t4 and t8 has been described, the present disclosure is not limited thereto, and the holding unit 106 may not be reset.

Although an example in which the counter control unit 103 clears the third bit counter 203 after outputting the most significant bit of the counter 102 has been described, the present disclosure is not limited thereto, and the third bit counter 203 may not be cleared. When the third bit counter 203 is not cleared, the calculation unit 108 counts the number of times the most significant bit held in the holding unit 106 is inverted from “0” to “1” or from “1” to “0”. The calculation unit 108 bit-shifts the number of times of inversion to calculate the higher-order bits of the pixel value.

The holding unit 106 may be configured to hold a value obtained by adding the number of the most significant bits “1”. In this case, the most significant bit of the counter 102 and the bit of the holding unit 106 are added, and the added value is held in the holding unit 106.

Although an example in which the holding unit 106 is a shift register has been described, the present disclosure is not limited thereto, and for example, another storage element such as a RAM (Random Access Memory) may be used.

The output unit 107 has been described as an example that outputs the bit values of the holding unit 106 in parallel, the present disclosure is not limited to this, and the bit values may alternatively be output serially.

According to the embodiments of the present disclosure, it is possible to realize an imaging device and a signal processing circuit capable of achieving both downsizing of a pixel and a high frame rate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-226166, filed Dec. 23, 2024, which is hereby incorporated by reference herein in its entirety.

What is claimed is:

1. An imaging device comprising a pixel, the pixel including:
a light receiving unit configured to receive light and generate a pulse signal;
a counter configured to count the pulse signal and hold a count value of a plurality of bits;
a holding unit configured to hold the count value; and
a switching unit configured to switch bit values of the count value to be held in the holding unit,
wherein the switching unit causes the holding unit to hold one or more higher-order bits of the count value a plurality of times, and
wherein the holding unit outputs a plurality of higher-order bits.

2. The imaging device according to claim 1,
wherein the switching unit causes the holding unit to hold the higher-order bits of the count value in a first period,
wherein the holding unit outputs the plurality of higher-order bits in a second period longer than the first period.

3. The imaging device according to claim 1, wherein the switching unit causes the holding unit to hold all the bits of the count value.

4. The imaging device according to claim 3, wherein the switching unit switches between a first operation mode in which the higher-order bits of the count value are held in the holding unit and a second operation mode in which all the bits of the count value are held in the holding unit.

5. The imaging device according to claim 3, further comprising a calculation unit configured to calculate a pixel value obtained by counting the pulse signal by combining the plurality of higher-order bits and all the bits.

6. The imaging device according to claim 5, wherein the calculation unit calculates the pixel value by combining a bit value obtained by bit-shifting the number of predetermined logical values included in the plurality of higher-order bits and all the bits.

7. The imaging device according to claim 1,
wherein the switching unit causes the holding unit to function as a shift register,
wherein the holding unit sequentially shifts and holds each of the plurality of higher-order bits.

8. The imaging device according to claim 2,
wherein the holding unit resets the higher-order bits after outputting the higher-order bits,
wherein the second period is from the reset of the holding unit until the higher-order bits of the count value are held in the holding unit the plurality of times.

9. The imaging device according to claim 1, wherein one higher-order bit is a most significant bit.

10. The imaging device according to claim 1, wherein each time the holding unit holds the higher-order bits, the counter clears the higher-order bits of the count value.

11. The imaging device according to claim 1, wherein the light receiving unit includes an avalanche photodiode that generates the pulse signal by receiving a photon.

12. A signal processing circuit comprising:
a counter configured to count a pulse signal from a light receiving unit and hold a count value of a plurality of bits;
a shift register configured to hold the count value; and
a switching unit configured to switch bit values of the count value to be held in the shift register,
wherein the switching unit causes the shift register to hold one or more higher-order bits of the count value a plurality of times,
wherein the shift register outputs a plurality of higher-order bits.

13. The signal processing circuit according to claim 12, wherein the shift register outputs each of the plurality of higher-order bits in parallel.

14. An equipment comprising:
the imaging device according to claim 1; and
at least one of:
an optical device corresponding to the imaging device,
a control device configured to control the imaging device,
a processing device configured to process a signal output from the imaging device,
a display device configured to display information obtained by the imaging device,
a storage device configured to store information obtained by the imaging device; and
a mechanical device configured to operate based on information obtained by the imaging device.

15. The equipment according to claim 14, wherein the processing device acquires distance information from the imaging device to an object.
